(19) United States
(12) Patent Application Publication
(10) Pub. No.: US 2002/0191019 A1
(43) Pub. Date: Dec. 19, 2002

(54) Displaying printer defaults with optional user intervention

(75) Inventor: Charles Michael Pickett, Brush Prairie, WA (US)

Correspondence Address: Julie L. Reed, MARGER JOHNSON & McCOLLOM, P.C., 1030 S.W. Morrison Street, Portland, OR, 97205, US

(73) Assignee: Sharp Laboratories of America, Inc., Camas, WA

(21) Appl. No.: 09/881,295

(22) Filed: Jun. 13, 2001

(51) Int. Cl. G06F 3/00

(52) U.S. Cl. 345/764

(57) ABSTRACT

One aspect of the disclosure is a method of providing a proxy user interface. A proxy user interface is provided for a secondary application activated by a user input. The proxy interface displays current or default settings for a task of that application. If no use input is received through the proxy interface, the task is performed. If a user input is received, the user interface for that application is presented to the user.

### BACKGROUND

1. Field

This disclosure relates to graphical user interfaces, more particularly to those user interfaces presented in conjunction with a primary user interface.

2. Background

Most computer users interact with their computer through a graphical user interface (GUI), either through the Microsoft® Windows® line of products, Macintosh® computers or similar applications on other types of workstations and computers. The primary user interface in these applications, usually referred to as the desktop, allow users to access and activate other applications having their own GUIs.

A common way for user to access and activate other applications is through mouse clicks on icons and shortcut buttons. The use of pointing devices, such as computer mice, has become so prevalent that it has contributed to a rise in repetitive strain injuries, also referred to as cumulative trauma injuries. For example, suppose a user wishes to access the word processing package on their personal computer. The user clicks on a shortcut icon, if one exists on the desktop. If the icon is not on the desktop, the user may click some other button to access a list of programs and then click on the icon for that program.

When the program then starts the user may click on menu items to format a document prior to actually starting to type the document. When the user desires to print, the user can typically click on a button with a printer on it. This will cause the default printer to execute a print job with default settings. If the user desires to see the default settings, the user has to launch the printer application from a different menu. The user will then click on some button in the printer application GUI to launch the print process with the defaults.

Even if there are no changes to the defaults, the only way the user can currently see the default settings for printing is to click several more times. This same problem occurs with other types of applications, such as sending e-mail or faxes from various document-creating applications such as word processors, spreadsheets, databases, etc. The use of shortcut icons and buttons happens in nearly ever commonly used application. However, no way exists for the user to see the defaults without having to make several more repetitive motions, and generally to use an inefficient approach.

In addition to the inefficiencies on the user side, there may be impacts on the computing side as well. Using the print example above, for example, the print GUI typically causes the primary GUI to freeze until the user makes a selection from the print GUI. Therefore, even if the user has no changes to the printer defaults and just wanted to view them, the computer still freezes the primary window. In this case, the ‘frozen’ primary window is the GUI for the word processor. The computer remains idle with respect to both the secondary application, in this example the print job, and the primary application until the user makes a selection. This interferes with the computing efficiency in the primary application.

It would therefore seem useful for a computer to present a GUI that allows the user to see the defaults for a secondary application without having to interfere with the primary application or require any user intervention if there are no changes.

### SUMMARY

One aspect of the disclosure is a method of providing a proxy user interface. A proxy user interface is provided for a secondary application activated by a user input. The proxy interface displays current or default settings for a task of that application. If no use input is received through the proxy interface, the task is performed. If a user input is received, the user interface for that application is presented to the user.

### BRIEF DESCRIPTION OF THE DRAWINGS

The invention may be best understood by reading the disclosure with reference to the drawings, wherein:

FIGS. 1a-b show one embodiment of a proxy graphical user interface, in accordance with the invention.

FIGS. 2a-2c show alternative embodiments of proxy graphical user interfaces, in accordance with the invention.

FIG. 3 shows a flowchart of one embodiment of a method for providing a proxy graphical user interface, in accordance with the invention.

### DETAILED DESCRIPTION OF THE EMBODIMENTS

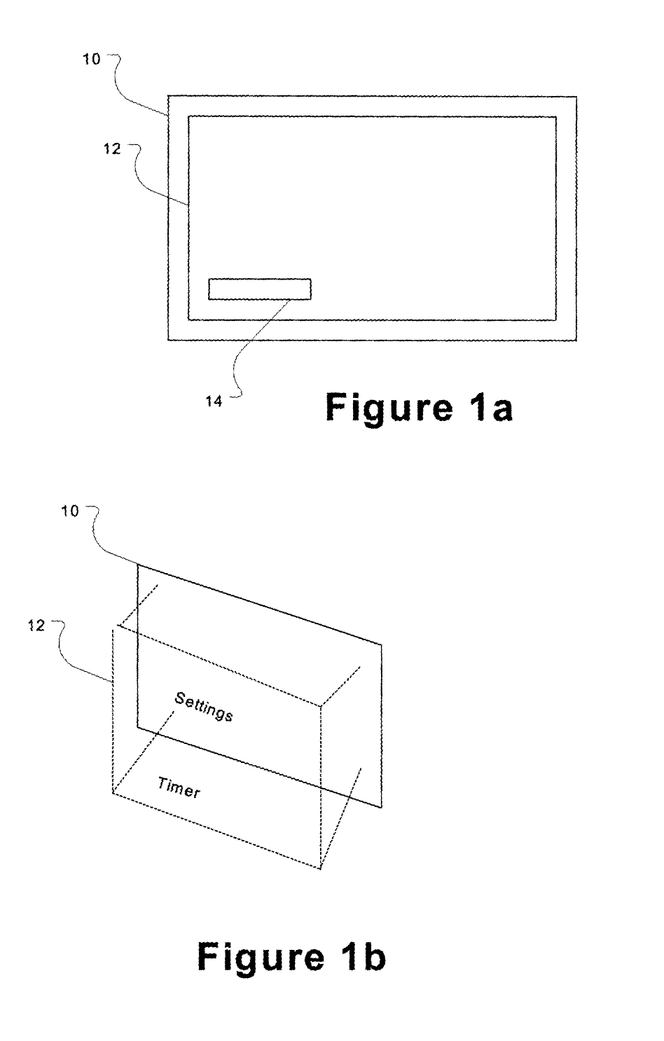

FIG. 1a shows a front view of one embodiment of a proxy user interface, in accordance with the invention. A graphical user interface for a primary application 10 is displayed upon the user's display device, such as a computer monitor. When the user makes an input that activates a secondary application, a proxy user interface for the secondary application 12 appears as a transparent overlay on the primary interface 10. This is shown in side view in FIG. 1b.

The interface for the secondary application is a proxy interface, as it is not the actual user interface for that application. Instead, it presents the default or current settings for the secondary application with no input fields or other features of a typical user interface. It may or may not also display a timer 14 that notifies the user of the intention to start the second application once a predetermined time period expires. This may be better understood with a simple example.

A user writes a document in a word processing application, which is the primary application displayed in the main window 10. The user wishes to print the document. Currently, the user could click on a small printer icon. This prints the document with whatever the default settings are, but the user does not get to see the default settings prior to the task being performed. The task in this example is the print job. Alternatively, the user may go to the ‘File’ menu and select ‘Print.’ As mentioned before, this then requires the user to confirm the settings, once they have been reviewed, even if no changes are made.

By applying the invention, the user would click on the print icon and the proxy user interface would appear. In this example, the proxy user interface would be a transparent overlay on the word processing window. The proxy user interface shows the user the current or default settings for the print job. If the user has no changes, the user can ignore the proxy user interface and continue performing tasks in the main application window. The main application window may have to be ‘brought forward’ to avoid entering any inputs on the proxy user interface, but that is an implementation issue left up to the interface designer. Once a time period has expired, the computer sends the print job to the printer and the proxy interface disappears.

If the user views the default or current settings and decides to make a change, the user can click on the proxy interface to notify the printer that changes are desired. At that point, the computer will typically launch the normal user interface for the printer, rather than providing an interactive proxy user interface. This seems the most efficient, although there is no limitation to prevent users from making their changes through the proxy interface. Similarly, in one embodiment, the user can notify the printer of changes by clicking anywhere on the proxy interface, or there can be a specified area, such as a “Stop” or “Change” button.

It must be noted that the example of a printer is only an example and should not be read to limit the scope of the invention in anyway. There are several examples of secondary applications that may be launched from a primary application that currently either perform the task with given settings, or present a user interface that then requires confirmation. Examples include printing, desktop faxing, sending a file by e-mail from within an application that creates or views the file, file operations such as saving or ‘saving as,’ among many others. Similarly, while many examples are set in the Microsoft Windows® environment, these are examples only and are not intended to limit the scope of the invention in any way. The Windows® environment is one of the more familiar environments for most users and was selected to promote understanding of the invention.

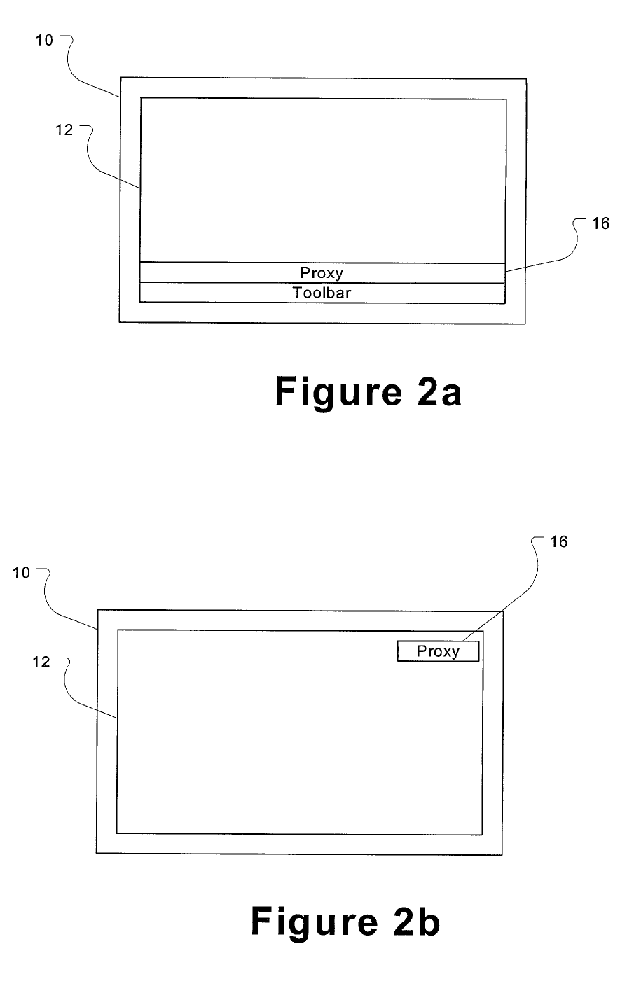

A characteristic of the proxy interface is that it is conveniently located while not interfering with the main application window. The transparent overlay is just one example among many that would allow the user to view the default or current settings of a secondary application. Some more examples are shown in FIGS. 2a-2b.

In FIG. 2a, for example, the proxy interface 16 is located somewhere on the periphery of the main application window. In the specific example of FIG. 2a, it is located in the upper right corner, however it may be located just about anywhere. An alternative location is shown in FIG. 2b, where the proxy interface is located as a bar just above the toolbar in a Windows® system. The location of the proxy interface is not important. It should allow the user to view the current or default settings for the secondary application and preferably not interfere with the main application window.

The default and current settings may vary depending upon the secondary application. In some instances there may be a set of default settings for the secondary application to which the secondary application returns after each task is performed, even if the particular task had different settings. In other instances, the user may make changes for a secondary application and those may remain until the user exits the secondary application, a certain period of time expires, or the user reboots the system. The proxy interface could be configured to display the current settings or the default settings, depending upon the user's preference.

In current systems, such as Windows 2000®, the user can view some of the default settings. For example, in MS Word®, the user can hover the cursor over the print icon and the text of “Print (printer name)” will appear, allowing the user to view the particular printer that is the current default printer. Similarly, the user can turn off the automatic use of default settings, which brings up the user interface for every secondary application. Following the example of the print process above, the print user interface is presented when the user clicks on the printer icon. However, in order to print, the user is again required to confirm the settings, even if there are no changes. Application of the current invention will only present this interface if the user notifies the computer of a desire to make changes.

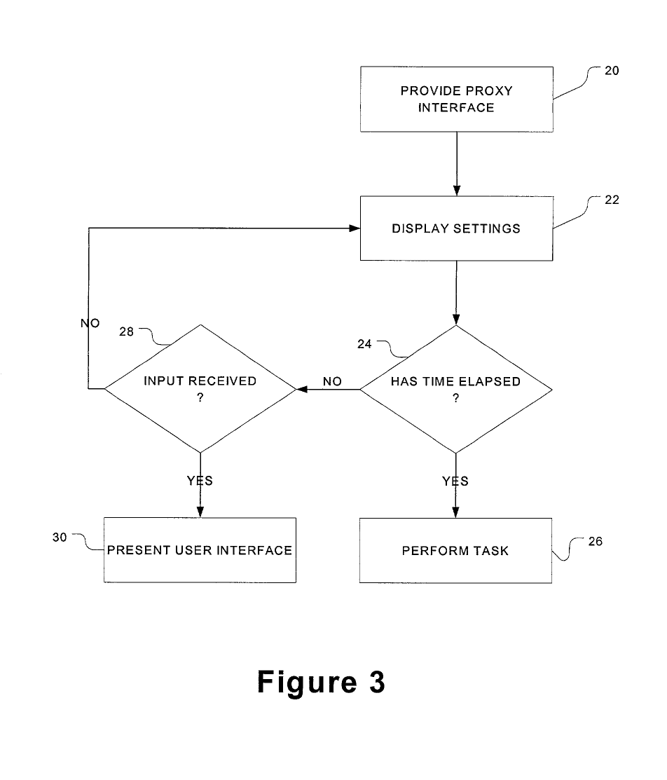

A flowchart for one embodiment of a process for presenting a proxy user interface is shown in FIG. 3. Upon receiving a user input activating a secondary application, the proxy user interface is displayed at 20. The settings are displayed on the proxy interface at 22, where the settings may be the current or default settings as discussed above. A predetermined time period for the proxy user interface begins to expire upon the start of this process. If the time period has elapsed at 24, the task is performed at 26. However, if the time period has not elapsed, the process continues to display the settings until the time has expired if the user makes no input.

If the user makes an input at 28, for example, a user interface for the secondary application is then presented at 30. As mentioned above, this will typically be the usual user interface for that application. However, the user interface could be the proxy interface where the displayed fields become active input fields. Again, if no input is received, the proxy interface is continued to be displayed until the time period expires and the task is performed.

In this manner, a user interface is provided that allows a user to view the default or current settings for a secondary application without having to provide confirmation or having to launch the usual user interface to determine what the settings are.

Thus, although there has been described to this point a particular embodiment for a method and apparatus for a proxy user interface, it is not intended that such specific references be considered as limitations upon the scope of this invention except in-so-far as set forth in the following claims.

What is claimed is:

1. A method of presenting a user interface, the method comprising:
a) providing a proxy user interface for a secondary application activated by a user input;
b) displaying settings for a task of the secondary application on the user interface; and
c) performing the task after elapse of a predetermined time period, if no input through the proxy interface is received.

2. The method of claim 1, wherein the method further comprises receiving an input through the proxy interface and presenting a user interface for the secondary application.

3. The method of claim 1, wherein the proxy user interface is provided as a transparent overlay.

4. The method of claim 1, wherein the proxy user interface is arranged on the periphery of the main application window.

5.The method of claim 1, wherein the settings displayed are the default settings for the application.

6. The method of claim 1, wherein the settings displayed are the current settings for the application.

7. A graphical user interface, comprising:
a) An identifier identifying the application for which the user interface is used;
b) A settings display, wherein the setting displayed are settings for the application; and
c) A timeout timer operable to close the graphical user interface upon expiration.

8. The graphical user interface of claim 8, wherein the timer is visible on the graphical user interface.

9. The graphical user interface of claim 8, wherein the timer is hidden.

10. The graphical user interface of the claim 8, wherein the settings are the default settings for the application.

11. The graphical user interface of claim 8, wherein the settings are the current settings for the application.

12. An article containing machine-readable code that, when executed, causes the machine to:
a) provide a proxy user interface for a secondary application activated by a user input;
b) display settings for a task of the secondary application on the user interface; and
c) perform the task using the settings displayed after elapse of a predetermined time period, if no input through the proxy interface is received.

13. The article of claim 13, wherein the article contains further code that, when executed, causes the machine to present a user interface for the secondary application upon reception of an input through the proxy user interface.

14. The article of claim 13, wherein the proxy user interface is provided as a transparent overlay of a main application window.

15. The article of claim 13, wherein the proxy user interface is provided on the periphery of a main application window.
